(19) United States
(12) Patent Application Publication
(10) Pub. No.: US 2026/0287783 A1
(43) Pub. Date: Sep. 24, 2026

(54) SYSTEMS AND METHODS FOR MULTI-SCALE SUBSURFACE MODELING

(71) Applicant: Chevron U.S.A. Inc., San Ramon, CA (US)

(72) Inventors: Lewis Li, Houston, TX (US); Lianshuang Qi, Sugar Land, TX (US); Aigul Tyshkanbayeva, Bellaire, TX (US)

(21) Appl. No.: 19/087,858

(22) Filed: Mar. 24, 2025

(51) Int. Cl. G01V 20/00

(52) U.S. Cl. CPC G01V 20/00; G01V 2210/665

(57) ABSTRACT

Modeling of a subsurface region is performed at different scales. Coarse modeling of the subsurface region is performed using coarse conditioning data to generate a coarse-scale representation of the subsurface region. Fine modeling of one or more parts of the subsurface region is performed using the corresponding part(s) of the coarse-scale representation and fine conditioning data to generate fine-scale representation(s) of the part(s) of the subsurface region. Spatial continuity and geological continuity are preserved between the different-scale representations.

### FIELD

The present disclosure relates generally to the field of generating finer-scale subsurface models from coarser-scale subsurface models.

### BACKGROUND

Models for subsurface regions may be generated at different scales. For example, a coarse-scale model that incorporates large areal trends may be generated for a large spatial region and fine-scale models may be generated for specific regions of interest (e.g., development regions). However, such modeling approaches may be difficult and time-consuming. Such modeling approaches may not ensure consistency between models of different scales.

### SUMMARY

This disclosure relates to multi-scale subsurface modeling. Conditioning information and/or other information may be obtained. The conditioning information may define multiple sets of conditioning characteristics for a subsurface region. The multiple sets of conditioning characteristics may include conditioning characteristics of different resolutions. The multiple sets of conditioning characteristics may include a first set of conditioning characteristics with a first resolution, a second set of conditioning characteristics with a second resolution higher than the first resolution, and/or other sets of conditioning characteristics. A first-scale subsurface representation of the subsurface region may be generated based on the first set of conditioning characteristics with the first resolution and/or other information. The first-scale subsurface representation of the subsurface region may include a cell that represents a portion within the subsurface region. A second-scale subsurface representation of a part of the subsurface region may be generated based on the first-scale subsurface representation of the subsurface region, the second set of conditioning characteristics with the second resolution, and/or other information. The second-scale subsurface representation of the part of the subsurface region may include multiple sub-cells that represent the portion within the subsurface region. Modeling of the subsurface region may be performed based on the first-scale subsurface representation of the subsurface region, the second-scale subsurface representation of the part of the subsurface region, and/or other information.

A system for multi-scale subsurface modeling may include one or more electronic storage, one or more processors and/or other components. The electronic storage may store information relating to a subface region, conditioning information, information relating to conditioning characteristics, information relating to subsurface representations, information relating to information relating to modeling of the subsurface region, and/or other information.

The processor(s) may be configured by machine-readable instructions. Executing the machine-readable instructions may cause the processor(s) to facilitate scale subsurface modeling. The machine-readable instructions may include one or more computer program components. The computer program components may include one or more of a conditioning component, a coarse-scale component, a fine-scale component, a modeling component, and/or other computer program components.

The conditioning component may be configured to obtain conditioning information, and/or other information. The conditioning information may define multiple sets of conditioning characteristics for a subsurface region. The multiple sets of conditioning characteristics may include conditioning characteristics of different resolutions. The multiple sets of conditioning characteristics may include a first set of conditioning characteristics with a first resolution, a second set of conditioning characteristics with a second resolution higher than the first resolution, and/or other sets of conditioning characteristics.

In some implementations, the conditioning information may include information from field exploration of the subsurface region, seismic exploration of the subsurface region, and/or production in the subsurface region.

The coarse-scale component may be configured to generate a first-scale subsurface representation of the subsurface region. The first-scale subsurface representation may be generated based on the first set of conditioning characteristics with the first resolution and/or other information. The first-scale subsurface representation of the subsurface region may include a cell that represents a portion within the subsurface region.

The fine-scale component may be configured to generate a second-scale subsurface representation of a part of the subsurface region. The second-scale subsurface representation of a part of the subsurface region may be generated based on the first-scale subsurface representation of the subsurface region, the second set of conditioning characteristics with the second resolution, and/or other information. The second-scale subsurface representation of the part of the subsurface region may include multiple sub-cells that represent the portion within the subsurface region.

In some implementations, a given sub-cell of the multiple sub-cells of the second-scale subsurface representation that represents the portion within the subsurface region may be populated with a given value based on a value of the cell of the first-scale subsurface representation that represents the portion within the subsurface region. In some implementations, the given sub-cell of the multiple sub-cells may be a center sub-cell of the multiple sub-cells. In some implementations, other sub-cells of the multiple sub-cells of the second-scale subsurface representation that represent the portion within the subsurface region may not be populated based on the value of the cell of the first-scale subsurface representation that represents the portion within the subsurface region.

In some implementations, the given value may be removed from the given sub-cell of the multiple sub-cells of the second-scale subsurface representation that represent the portion within the subsurface region based on the second set of conditioning characteristics with the second resolution including a conditioning characteristic value for the portion within the subsurface region and/or other information. In some implementations, a non-center sub-cell of the multiple sub-cells of the second-scale subsurface representation that represents the portion within the subsurface region may be populated with the conditioning characteristic value for the portion within the subsurface region based on the conditioning characteristic value corresponding to a non-center location within the portion.

In some implementations, statistical correction may be performed to generate the second-scale subsurface representation of the part of the subsurface region.

The modeling component may be configured to perform modeling of the subsurface region. The modeling of the subsurface region may be performed based on the first-scale subsurface representation of the subsurface region, the second-scale subsurface representation of the part of the subsurface region, and/or other information.

In some implementations, spatial continuity and geological continuity may be preserved between the first-scale subsurface representation of the subsurface region and the second-scale subsurface representation of the part of the subsurface region.

In some implementations, production in the subsurface region may be facilitated based on the modeling of the subsurface region and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for multi-scale subsurface modeling.

FIG. 2 illustrates an example method for multi-scale subsurface modeling.

FIG. 3 illustrates an example process for multi-scale subsurface modeling.

FIG. 4 illustrates an example coarse-scale representation of a subsurface region.

FIG. 5A illustrates an example population of a fine-scale representation of a part of a subsurface region.

FIG. 5B illustrates an example population of a fine-scale representation of a part of a subsurface region.

FIG. 6 illustrates a part of an example coarse-scale representation and an example fine-scale representation.

FIG. 7 illustrates an example statistical correction in modeling a fine-scale subsurface representation.

FIG. 8 illustrates an example combined representation of a subsurface region.

### DETAILED DESCRIPTION

The present disclosure relates to multi-scale subsurface modeling. Modeling of a subsurface region is performed at different scales. Coarse modeling of the subsurface region is performed using coarse conditioning data to generate a coarse-scale representation of the subsurface region. Fine modeling of one or more parts of the subsurface region is performed using the corresponding part(s) of the coarse-scale representation and fine conditioning data to generate fine-scale representation(s) of the part(s) of the subsurface region. Spatial continuity and geological continuity are preserved between the different-scale representations.

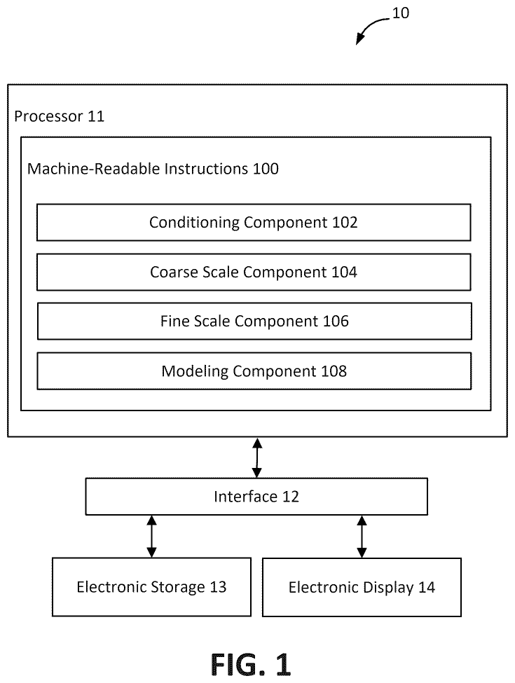

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Conditioning information and/or other information may be obtained by the processor 11. The conditioning information may define multiple sets of conditioning characteristics for a subsurface region. The multiple sets of conditioning characteristics may include conditioning characteristics of different resolutions. The multiple sets of conditioning characteristics may include a first set of conditioning characteristics with a first resolution, a second set of conditioning characteristics with a second resolution higher than the first resolution, and/or other sets of conditioning characteristics. A first-scale subsurface representation of the subsurface region may be generated by the processor 11 based on the first set of conditioning characteristics with the first resolution and/or other information. The first-scale subsurface representation of the subsurface region may include a cell that represents a portion within the subsurface region. A second-scale subsurface representation of a part of the subsurface region may be generated by the processor 11 based on the first-scale subsurface representation of the subsurface region, the second set of conditioning characteristics with the second resolution, and/or other information. The second-scale subsurface representation of the part of the subsurface region may include multiple sub-cells that represent the portion within the subsurface region. Modeling of the subsurface region may be performed by the processor 11 based on the first-scale subsurface representation of the subsurface region, the second-scale subsurface representation of the part of the subsurface region, and/or other information.

The electronic storage 13 may include one or more non-transitory storage media configured to electronically store information. The electronic storage 13 may store software algorithms, information determined by the processor 11, information received remotely, and/or other information that enables the system 10 to function properly. For example, the electronic storage 13 may store information relating to a subface region, conditioning information, information relating to conditioning characteristics, information relating to subsurface representations, information relating to information relating to modeling of the subsurface region, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a subface region, conditioning information, information relating to conditioning characteristics, information relating to subsurface representations, information relating to information relating to modeling of the subsurface region, and/or other information.

A challenge in modeling a subsurface region is that different scales of modeling may capture subsurface features of different sizes. For example, a coarse-scale modeling may be used to capture large areal trends in a subsurface region while a fine-scale modeling may be used to investigate fine details in the subsurface region. While the coarse-scale modeling may be used for a subsurface region and the fine-scale modeling may be used for specific regions of interest within the subsurface region, performing subsurface modeling at different scales may be difficult and time consuming. Additionally, outputs of different-scale modeling may not be consistent with each other. For instance, a coarse-scale model of a subsurface region and a fine-scale model of a part of the subsurface region may be generated using modeling of different scales. The coarse-scale model of the subsurface region and the fine-scale model of the part of the subsurface region may be combined, but the combination may result in spatial and geological discontinuities between the models of different scales.

For example, development of adjacent/nearby reservoirs (e.g., conventional reservoir, unconventional reservoir, such as shale and tight gas reservoir) may require generation of accurate subsurface representations (computer model of a subsurface region) for the reservoirs. Challenges in generating such subsurface representations include (1) ensuing spatial and geological continuities between adjacent/nearby subsurface representations, (2) retainment of large-scale information, such as depositional trends, across subsurface representations, and (3) utilizing correct statistics from data dense regions to inform modeling of data sparse regions. There is no standard/accepted mechanism for generating subsurface representations of different scales that are consistent with each other. Moreover, changing the scales of subsurface representations (e.g., from coarse-scale to fine-scale) introduces other issues, such as ensuring consistency between individual modeled subsurface properties and a change in variance due to the change in scale (resolution).

The present disclosure provides a tool for multi-scale subsurface modeling with spatial and geological continuities being preserved between outputs of different scale modeling. The present disclosure enables multiscale heterogeneity within a subsurface region to be accurately modeled using subsurface representations of different scales. The present tool allows subsurface representations to be generated at different scales (e.g., pore scale to well log scale, well log scale to reservoir model scale, reservoir model scale to reservoir flow simulator scale, reservoir model scale to basin model scale) while preserving consistency between subsurface representations of different scales.

The present disclosure may be used to generate and combine subsurface representations of multiple scales. For example, coarse-scale modeling may be used to generate coarse-scale subsurface representations (e.g., regional subsurface representations) while fine-scale modeling may be used to generate fine-scale subsurface representations (e.g., sub-regional subsurface representations, reservoir models). The dimensions of volume represented by cells of the coarse-scale subsurface representations and fine-scale subsurface representations may be different. For example, a coarse-scale subsurface representation may include cells that represent volumes with lateral dimensions of hundreds to thousands of feet. A fine-scale subsurface representation may include cells that represent volumes with lateral dimensions of tens to hundreds of feet. The cells of a coarse-scale subsurface representation and a fine-scale subsurface representation may represent the same vertical dimension, such as tens of feet. While the current disclosure is described with respect to two scales, this is merely an example and is not meant to be limiting. Use of other numbers of scales and representation of other dimensions are contemplated.

In the two-scale example, coarse-scale modeling may integrate large scale trends as well as downscaled well logs in a coarse-scale subsurface representation for a subsurface region. The regional subsurface representation may contain all subsurface properties of interest, such as mineralogy, petrophysical properties, and geo-mechanical properties. The coarse-scale modeling may utilize structural modeling and multivariate property modeling to ensure that data consistency and multivariate correlations are preserved.

Regions of interest (focus areas) within the subsurface region may be identified for fine-scale modeling. Parts of the coarse-scale subsurface representation may be extracted and used to construct fine-scale subsurface representations. Separate fine-scale subsurface representations may be generated for different regions of interest and for individual subsurface properties of interest. A fine-scale subsurface representation for a region of interest may be generated by extracting the corresponding part of the coarse-scale subsurface representation and then dividing individual cells in the extracted part of the coarse-scale subsurface representation into a set of evenly spaced cells (according to the desired upscaling factor). For a subsurface property being modeled, the value of the subsurface property from the extracted part of the coarse-scale subsurface representation may be copied into the corresponding location in the fine-scale subsurface representation to be used as conditioning data. This ensures that large scale trends captured in the coarse-scale subsurface representation are retained in the fine-scale subsurface representation. Furthermore, this ensures that spatially adjacent subsurface representations (between coarse-scale subsurface representation and fine-scale subsurface representation, between fine-scale subsurface representations) are consistent with each other.

Other conditioning data may be scaled and used as additional conditioning data in generating the fine-scale subsurface representation. For example, well logs that fall within the region of interest for a fine-scale subsurface representation are downscaled onto the fine-scale grid and used as additional conditioning data. This ensures that regardless of scale/resolution, the subsurface representations are conditioned to the wells.

Conditioning data may include real/field measurement data (e.g., well logs, seismic data) and/or simulated data (e.g., subsurface properties from physics-based modeling). Conditioning data of different scales may be used for modeling at different scales. Different types of conditioning data may be obtained (measured) at different scales and the scales of the conditioning data may determine the scales at which they are used to condition the modeling. Finer-scale conditioning data (e.g., well logs) may be downscaled (scaled down in resolution) for incorporation in coarser-scale modeling. Coarser-scale conditioning data (e.g., seismic data) may not be upscaled (scaled up in resolution) for incorporation in finer-scale modeling.

With the fine-scale subsurface representation containing regularly spaced sets of conditioning data from the coarse-scale subsurface representation, the spatial behavior of the subsurface properties may be constrained. The coarse-scale subsurface representation may be used to ensure that large-scale trends in the subsurface region are maintained in the fine-scale subsurface representations. Use of scale-appropriate conditioning data as anchor points ensures that fine-scale subsurface representations are consistent with adjacent subsurface representations without any overlaps with the adjacent subsurface representations.

Individual subsurface properties may be modeled independently while still retaining the multivariate correlations that were established in the coarse-scale subsurface representation. This independence enables fine-scale subsurface properties to be modeled separately and enables the use of parallel computing.

Additional pre and/or post-processing may be performed for compositional subsurface properties that must sum up to one. For these subsurface properties, an isometric log ratio transform may be applied to the compositional subsurface property conditioning data. Scaling of these properties may be performed on the transformed values before the isometric log ratio transform is reversed to yield final compositional subsurface properties.

Scaling of individual subsurface properties may be performed using conditional Gaussian simulation, such as sequential Gaussian simulation. However, the variograms and the target distributions of individual subsurface properties in the fine-scale subsurface representation may be different from those in the coarse-scale subsurface representation due to the change of support phenomenon. The distribution in the coarse-scale subsurface representation may tend to be more Gaussian than the distribution in the fine-scale subsurface representation and have a lower variance which can be defined by the volume-variance relation. Statistical correction (e.g., de-biasing, histogram correction) may be performed to ensure the accuracy and reliability of the fine-scale subsurface representation.

The tool of the present disclosure provides automation of time-consuming workflow. Changes to the coarse-scale subsurface representation may be propagated through to the fine-scale subsurface representation automatically as individual fine-scale subsurface representation is linked back to the coarse-scale subsurface representation.

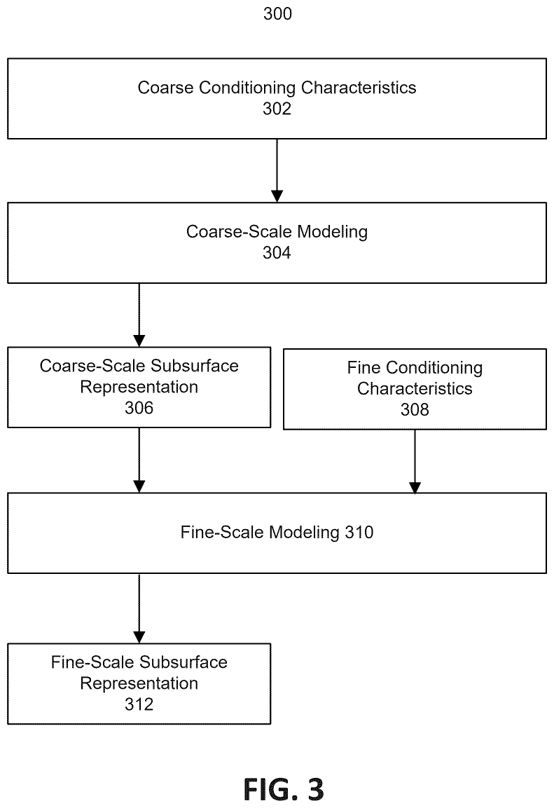

FIG. 3 illustrates an example process 300 for multi-scale subsurface modeling. Coarse conditioning characteristics 302 for a subsurface region may be obtained. The coarse conditioning characteristics 302 may define values of subsurface properties within the subsurface region. The coarse conditioning characteristics 302 may be used to perform coarse-scale modeling 304. The coarse-scale modeling 304 may generate a coarse-scale subsurface representation 306. The coarse-scale subsurface representation 306 may define simulated subsurface configuration of the subsurface region. The coarse-scale subsurface representation 306 may include cells that define values of simulated subsurface properties within the subsurface region.

Fine conditioning characteristics 308 for the subsurface region may be obtained. The fine conditioning characteristics 308 may define values of subsurface properties within the subsurface region. The fine conditioning characteristics 308 may have higher resolution than the coarse conditioning characteristics 302. The fine conditioning characteristics 308 may define values of subsurface properties within the subsurface region at a smaller scale than the coarse conditioning characteristics 302.

The coarse-scale subsurface representation 306 and the fine conditioning characteristics 308 may be used to perform fine-scale modeling 310. The fine-scale modeling 310 may be performed for a part of the subsurface region (e.g., region of interest within the subsurface region). The fine-scale modeling 310 may generate a fine-scale subsurface representation 312. Statistical corrections may be performed to ensure accuracy and reliability of the fine-scale subsurface representation 312. The fine-scale subsurface representation 312 may define simulated subsurface configuration of the part of the subsurface region. The fine-scale subsurface representation 312 may include cells that define values of simulated subsurface properties within the subsurface region.

The cells of the fine-scale subsurface representation 312 may represent smaller volumes than the cells of the coarse-scale subsurface representation 306. The fine-scale subsurface representation 312 may have higher resolution than the coarse-scale subsurface representation 306. The fine-scale subsurface representation 312 may define values of subsurface properties within the subsurface region at a smaller scale than the coarse-scale subsurface representation 306. For a process in which more than two scales of modeling are performed, the fine-scale subsurface representation 312 may be used as a coarse-scale subsurface representation in the next scale of fine-scale modeling. Use of the latest generated fine-scale subsurface representation as the coarse-scale subsurface representation may be repeated until the desired scales of modeling have been performed.

The coarse-scale subsurface representation 306 and the fine-scale subsurface representation 312 may be combined to generate a multi-scale subsurface representation for the subsurface region, with the multi-scale subsurface representation having higher resolution for the part of the subsurface region.

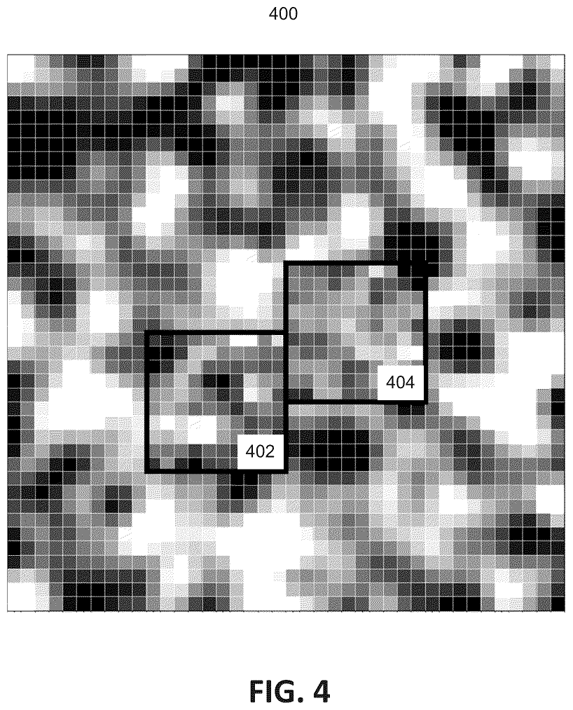

FIG. 4 illustrates an example coarse-scale representation 400 of a subsurface region. While the present disclosure is described with respect to two-dimensional representations (slices of three-dimensional representations), this is merely as an example and is not meant to be limiting. Use of other dimensions of subsurface representations are contemplated.

The coarse-scale representation 400 may define simulated subsurface configuration of the subsurface region. The coarse-scale representation 400 may include cells that define values of simulated subsurface properties at a coarse-scale. The lateral dimensions of the cells may be the same. The vertical dimension of the cells may be independent of the lateral dimensions of the cells. For example, the coarse-scale representation 400 may be constructed on a 3D grid with large spatial extent (e.g., 10-100km) grid built by incorporating conditioning information from thousands of wells (e.g., 10-20 logs per well). Individual cells in the coarse-scale representation may represent a volume having lateral dimensions of 500-1000 feet and vertical dimension of 10 feet. The coarse-scale representation 400 may capture large spatial trends in the subsurface region. The low resolution of the coarse-scale representation 400 may make it insufficient for use in certain subsurface operations, such as fracture simulation and well planning. Parts 402, 404 of the coarse-scale representation 400 may represent regions of interest (e.g., development areas) within the subsurface region. The tools of the present disclosure may be used to generate fine-scale representations of the parts 402, 404 that are both self-consistent and linked to the coarse-scale representation 400. The parts 402, 404 of the coarse-scale representation 400 may be extracted for use in modeling the coarse-scale representations of the parts 402, 404.

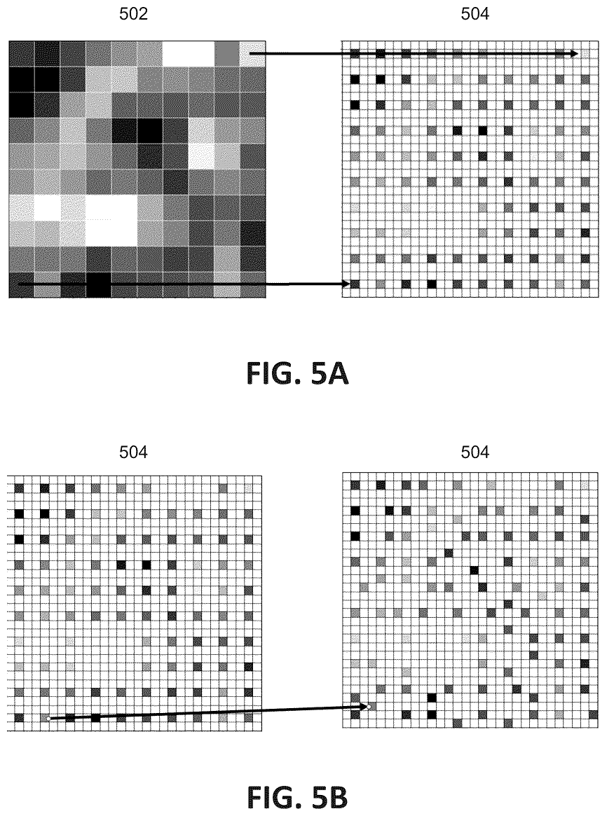

FIG. 5A illustrates an example population of a fine-scale representation of a part of a subsurface region. FIA. 5A illustrates example population of a fine-scale representation 504 using values from a coarse-scale representation 502. A part of a larger coarse-scale representation may be extracted for use in modeling a fine-scale representation of the part of the subsurface region. In FIG. 5A, the coarse-scale representation 502 may be the part 402 of the coarse-scale representation 400. The cells of the coarse scale representation 502 may be divided into multiple sub-cells to create cells of the fine-scale representation 504. For example, in FIG. 5A, a single cell of the coarse scale representation 502 may be divided into nine sub-cells. This may result in the cells of the fine-scale representation 504 having smaller lateral dimensions than the cells of the coarse scale representation 502 (e.g., ⅓ as long).

In some implementations, the vertical dimension of the cells in the representations 502, 504 may remain the same. In some implementations, the vertical dimension of the cells in the representations 502, 504 may be different the same. For example, in addition to dividing the lateral dimensions of the cells, the vertical dimension of the cells may be divided to create the cells of the fine-scale representation.

The coarse scale representation 502 and the fine-scale representation 504 may represent the same part of the subsurface region. The coarse scale representation 502 and the fine-scale representation 504 may have the same spatial coverage. Cells of the fine-scale representation 504 may be populated with values to match the values in the cells of the coarse-scale representation 502. Spatial matching may be performed to map values from the coarse-scale representation 502 into the fine-scale representation 504.

A portion of the subsurface region may be represented by a single cell in the coarse scale representation 502 and by multiple cells in the fine-scale representation 504. For example, the same portion of the subsurface region represented by a single cell in the coarse scale representation 502 may be represented by nine cells in the fine-scale representation 504. A single cell of the fine-scale representation 504 that maps to a cell of the coarse-scale representation 502 may be populated with the value from the cell of the coarse-scale representation 502. For example, a cell of the fine-scale representation that is closest in space to the corresponding cell of the coarse-scale representation 502 may be populated. For instance, in FIG. 5A, the center cell of the fine-scale representation 504 may be populated with the value from the corresponding cell of the coarse-scale representation 502. In some implementations, non-center cell of the fine-scale representation 504 may be populated with the value from the corresponding cell of the coarse-scale representation 502. Other cells of the fine-scale representation 504 may be left empty (not populated with the value from the corresponding cell of the coarse-scale representation 502). This may result in most of the fine-scale representation 504 being empty.

FIG. 5B illustrates an example population of a fine-scale representation of a part of a subsurface region. FIG. 5B illustrates an example population of a fine-scale representation using values from conditioning data. Values of cells in the fine-scale representation 504 may be changed as shown in FIG. 5B. Conditioning data may provide values of conditioning characteristics (values of subsurface properties) for specific locations within the subsurface region. Conditioning data with scale/resolution that makes the scale/resolution of the fine-scale representation may be used to populate the fine-scale representation. Conditioning data with finer scale/higher resolution may be downscaled for use in populating the fine-scale representation. For example, well logs may provide finest scale/highest resolution for conditioning data. Well logs may be downscaled to populate fine-scale representations at multiple levels of modeling. As the scale of the fine-scale representation gets finer, the population from the well log may become more accurate/precise.

Population from the conditioning data may override the existing value of the cell in the fine-scale representation. Population from the conditioning data may override the values in the fine-scale representation that came from the coarse-scale representation. The value in the fine-scale representation that came from the coarse-scale representation may be removed to prevent bias, and the value from the conditioning data may be shifted to more precise location in the fine-scale representation. The value from the conditioning data may be shifted to more precise lateral location in the fine-scale representation. For fine-scale representation having cells with finer vertical dimensions, the value from the conditioning data may be shifted to more precise vertical location in the fine-scale representation.

For example, a grouping of nine cells in the fine-scale representation 504 may include a cell that was populated with the value from the corresponding cell in the coarse-scale representation 502. Conditioning data for the fine-scale representation 504 may include a value for a location within the portion of the subsurface region represented by the nine cells. Since higher quality (more accurate, more reliable) conditioning data is available for this portion of the subsurface region, the value from the coarse-scale representation 502 may be removed (value in the center of nine cells removed) and the value from the conditioning data may be inserted into the cell that overlaps with the location from the conditioning data was obtained. For example, looking at the bottom right corner of the fine-scale representation 504, the value in the center cell in the bottom right group of nine cells may be removed and the value from the conditioning data may be inserted to the right of the center cell. The replaced value may be more accurate in both the value of subsurface property and location of subsurface property measurement.

While the population process has been described in three steps, first populating the fine-scale representation with values from the coarse-scale representation, removing the populated values when conditioning data is available, and then populating the values from the conditioning data, the population process may be performed in other ways (e.g., combining the three steps into a single step, combining two of the steps into a single steps, diving the three steps into other number of steps).

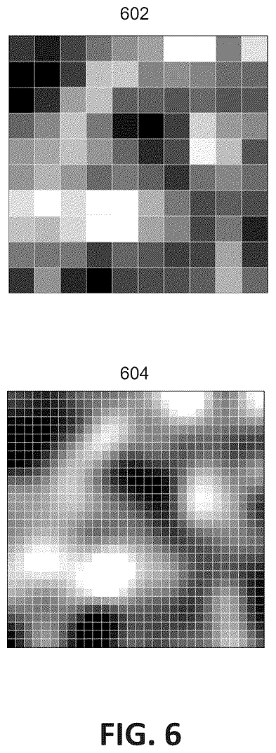

After the population of the fine-scale representation using conditioning data, fine-scale modeling may be performed to populate empty cells of the fine-scale representation. FIG. 6 illustrates a part of an example coarse-scale representation 602 and an example fine-scale representation 604. The fine-scale representation 604 may incorporate data from the coarse-scale representation 602 and finer-scale conditioning data. The coarse-scale representation 602 and the fine-scale representation 604 may be spatially and geologically consistent. The fine-scale representation 604 may maintain the large trends modeled in the coarse-scale representation 602 while having finer resolution and more precise/accurate placement of values from finer conditioning data.

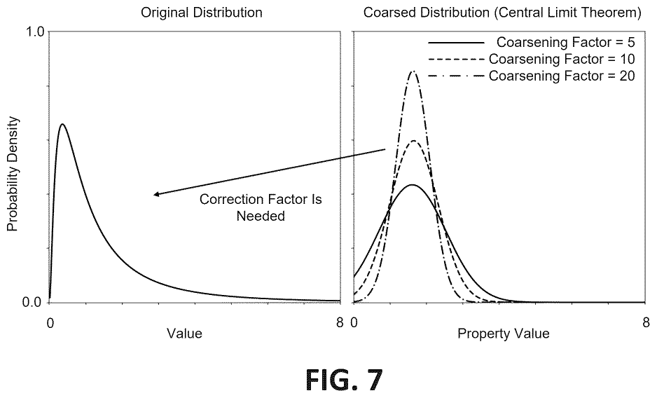

FIG. 7 illustrates an example statistical correction in modeling a fine-scale representation. The variograms and the target distributions of individual subsurface properties in a fine-scale subsurface representation may be different from those in a coarse-scale subsurface representation due to the change of support phenomenon. The distributions of subsurface properties may change based on the central limit theorem. Statistical correction may be performed in modeling the fine-scale representation to ensure the accuracy and reliability of the fine-scale subsurface representation. Modeling may require a correction term to ensure accurate distribution of subsurface properties. For example, statistical correction may be performed to widen the distribution during modeling (e.g., geostatistical simulation). A correction factor may be used, with the value of the correction factor determined based on empirical relationships. Different changes in scale between the coarse-scale subsurface representation and the fine-scale subsurface representation may require different correction factors.

For example, a fine-scale subsurface representation of a part of a subsurface region may have different histogram/probability density function from the corresponding part of the coarse-scale subsurface representation. Correction factor may be used to add probability density function values to tails of the distribution on the fine-scale subsurface representation. FIG. 7 shows use of different factors based on differences in scale between the coarse-scale subsurface representation and the fine-scale subsurface representation.

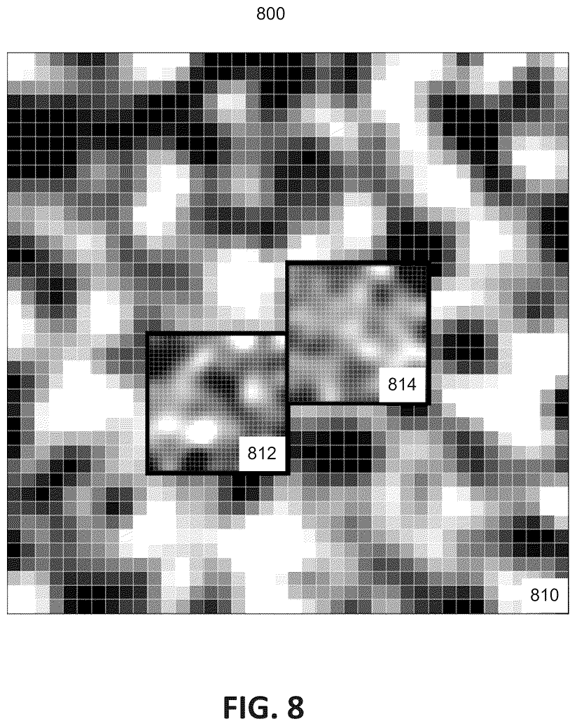

FIG. 8 illustrates an example combined representation 800 of a subsurface region. The combined representation 800 may include a multi-scale subsurface representation. The combined representation 800 may include coarse-scale representation 810 of the subsurface region and fine-scale representations 812, 814 of regions of interest within the subsurface region. The fine-scale representations 812, 814 may be linked to the coarse-scale representation 810. The representations 810, 812, 814 may be consistent with each other. Spatial continuity and geological continuity may be preserved between the representations 810, 812, 814.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate multi-scale subsurface modeling. The machine-readable instructions 100 may include one or more computer program components. The machine-readable instructions 100 may include a conditioning component 102, a coarse-scale component 104, a fine-scale component 106, a modeling component 108, and/or other computer program components.

The conditioning component 102 may be configured to obtain conditioning information, and/or other information. Obtaining conditioning information may include one or more of accessing, acquiring, analyzing, creating, determining, examining, generating, identifying, loading, locating, measuring, opening, receiving, retrieving, reviewing, selecting, storing, utilizing, and/or otherwise obtaining the conditioning information. The conditioning component 102 may obtain conditioning information from one or more locations. For example, the conditioning component 102 may obtain conditioning information from a storage location, such as the electronic storage 13, electronic storage of a device accessible via a network, and/or other locations. The conditioning component 102 may obtain conditioning information from one or more hardware components (e.g., a computing device, a component of a computing device) and/or one or more software components (e.g., software running on a computing device). Conditioning information may be stored within a single file or multiple files.

The conditioning information may define multiple sets of conditioning characteristics for a subsurface region. The multiple sets of conditioning characteristics may include conditioning characteristics of different resolutions. The multiple sets of conditioning characteristics may include conditioning characteristics at different scales. For example, the multiple sets of conditioning characteristics may include a coarse set of conditioning characteristics with a coarse resolution (coarse scale), a fine set of conditioning characteristics with a fine resolution (fine scale) higher than the coarse resolution, and/or other sets of conditioning characteristics. Use of more than two sets of conditioning characteristics (more than two levels of resolution/scale) is contemplated.

The conditioning information may define conditioning characteristics as a function of location (e.g., vertical spatial location, such as depth; lateral spatial location, such as x-y coordinate in map view) within the subsurface region. A subsurface region may refer to a part of earth located beneath the surface/located underground. A subsurface region may refer to a part of earth that is not exposed at the surface of the ground. A subsurface region may be defined in a single dimension (e.g., a point, a line) or in multiple dimensions (e.g., a surface, a volume).

A conditioning characteristic may refer to subsurface feature, property, quantity, and/or quality of the subsurface region that is desired to be preserved within a subsurface representation. A conditioning characteristic may refer to a characteristic of the subsurface region that is to be preserved with a subsurface representation. Conditioning characteristics may define guides/constraints and/or fixed points in generating subsurface representations. Conditioning characteristics may include subsurface feature, property, quantity, and/or quality of one or more subsurface points, areas, and/or volumes of interest. Conditioning characteristics may include hard data, soft data, and/or other data. In some implementations, conditioning characteristics may include geological characteristics, petrophysical characteristics, geophysical characteristics, seismic characteristics, and/or other subsurface characteristics.

Examples of conditioning characteristics include rock properties (e.g., rock types, layers, grain sizes, porosity, permeability), minerology (e.g., compositional data such as percentage of calcite, percentage of illite, etc., with the composition percentages summing up to one in individual cells of subsurface representation), seismic data (e.g., acoustic impedance, inversion results), and simulated data (e.g., conditioning characteristics simulated using a forward model to model geological continuity). Usage of other subsurface properties as conditioning characteristics are contemplated.

The conditioning information may define a conditioning characteristic by including information that describes, delineates, identifies, is associated with, quantifies, reflects, sets forth, and/or otherwise defines one or more of content, quality, attribute, feature, and/or other aspects of the conditioning characteristic. For example, the conditioning information may define a conditioning characteristic by including information that makes up the conditioning characteristic and/or information that is used to identify/determine the conditioning characteristic. Other types of conditioning information are contemplated.

In some implementations, the condition information may define conditioning characteristics at one or more points, one or more lines, one or more surfaces, one or more laterals/rows, one or more verticals/columns, and/or one or more volumes within a subsurface region. Conditioning characteristics may be defined at other locations within a subsurface region.

In some implementations, the conditioning information may include information from field exploration of the subsurface region, seismic exploration of the subsurface region, and/or production in the subsurface region. For example, conditioning information may include information obtained and/or derived from field exploration of the subsurface region, seismic exploration of the subsurface region, and/or production in the subsurface region. For instance, conditioning information may include information from seismic maps, well logs, petrophysical logs, mineralogy logs, seismic data, and/or production data. In some implementations, the conditioning information may include information from simulation of subsurface regions, such as three-dimensional models of Earth.

The coarse-scale component 104 may be configured to generate one or more coarse scale subsurface representation of the subsurface region. A subsurface model may be run to generate a coarse-scale subsurface representation. A subsurface model may refer to a computer model (e.g., program, tool, script, function, process, algorithm) that generates subsurface representations. A subsurface model may simulate subsurface configuration within a region underneath the surface (subsurface region). Subsurface configuration may refer to attribute, quality, and/or characteristics of a subsurface region. Subsurface configuration may refer to physical arrangement of materials (e.g., subsurface elements) within a subsurface region. Examples of subsurface configuration simulated by a subsurface model may include types of subsurface materials, characteristics of subsurface materials, compositions of subsurface materials, arrangements/configurations of subsurface materials, physics of subsurface materials, and/or other subsurface configurations. For instance, subsurface configuration may include and/or define types, shapes, and/or properties of materials and/or layers that form subsurface (e.g., geological, petrophysical, geophysical, stratigraphic) structures.

A subsurface model may simulate subsurface properties by generating one or more subsurface representations. A subsurface representation may refer to a computer-generated representation of a subsurface region, such as a one-dimensional, two-dimensional, and/or three-dimensional model of the subsurface region. A subsurface representation may be representative of one or more depositional environments. A subsurface representation may define simulated subsurface configuration within a subsurface region. A subsurface representation may be defined by and/or include the subsurface properties simulated by the subsurface model.

A coarse-scale subsurface representation may be generated based on one or more sets of conditioning characteristics with the coarse resolution and/or other information. The coarse-scale subsurface representation of the subsurface region may include a cell that represents a portion within the subsurface region. For example, FIG. 4 illustrates an example coarse-scale representation 400 of a subsurface region.

The fine-scale component 106 may be configured to generate one or more fine-scale subsurface representation. A subsurface model may be run to generate a fine-scale subsurface representation. A fine-scale subsurface representation may be generated automatically and/or generally manually with varying geometry. Fine-scale subsurface representation(s) may be generated for one or more parts of the subsurface region. Fine-scale subsurface representation(s) may be generated for some or all parts of the subsurface region. For example, FIG. 4 shows two parts 402, 404 of the coarse-scale representation 400 that represent regions of interest (e.g., development areas) within the subsurface region. The fine-scale component 106 may generate fine-scale subsurface representations for these regions of interest. In some implementations, statistical correction may be performed to generate the fine-scale subsurface representation(s). FIG. 6 illustrates examples of the coarse-scale representation 602 and the fine-scale representation 604 that cover the same part of the subsurface region.

A fine-scale subsurface representation may be generated based on the coarse-scale subsurface representation of the subsurface region, one or more sets of conditioning characteristics with the fine resolution, and/or other information. The part of the coarse-scale subsurface representation that corresponds to the fine-scale subsurface representation may be used to generate the fine-scale subsurface representation.

The coarse-scale subsurface representation of the subsurface region may include a cell that represents a portion within the subsurface region, while the fine-scale subsurface representation of the part of the subsurface region may include multiple sub-cells that represent the portion within the subsurface region. For example, as shown in FIG. 5, a cell of the coarse-scale representation 502 may correspond to nine cells of the fine-scale representation 504.

In some implementations, a sub-cell of the fine-scale subsurface representation may be populated with a value based on a value of the corresponding cell of the coarse-scale subsurface representation. For example, as shown in FIG. 5A, a value of a cell in the coarse-scale representation 502 may be used to populate (e.g., copied into) one of the nine corresponding cells in the fine-scale representation 504. In FIG. 5A, the value of the cell in the coarse-scale representation 502 is used to populate a center sub-cell. Other sub-cells of the fine-scale subsurface representation may be populated using the values of the coarse-scale representation. Other sub-cells of the fine-scale representation may not be populated based on the value in the corresponding cell of the coarse-scale representation. For example, as shown in FIG. 5A, eight of nine sub-cells in the fine-scale representation 504 may not be populated based on the value in the coarse-scale representation 502.

In some implementations, a value may be removed from a sub-cell of the fine-scale subsurface representation based on the set of conditioning characteristics with the fine resolution including a conditioning characteristic value for the corresponding portion within the subsurface region and/or other information. If a conditioning characteristic value exists for use in fine-scale subsurface modeling, the value for the same location that came from the coarse-scale subsurface representation may be removed from the fine-scale subsurface representation. A sub-cell of the coarse-scale subsurface representation may be populated with the conditioning characteristic value. The location of the sub-cell that is populated may depend on/match the location corresponding to the conditioning characteristic value. For example, as shown in FIG. 5B, values in center sub-cell may be removed and the conditioning characteristic value may be inserted into the corresponding sub-cell (e.g., shifted to the right in the bottom right group of nine cells).

In some implementations, more than two scales of subsurface representations may be generated. To generate a finer-scale subsurface representation, the fine-scale subsurface representation may be treated as a coarse-scale subsurface representation. Conditioning characteristics that match the resolution/scale of the modeling being performed may be used to populate the fine-scale subsurface representation.

The modeling component 108 may be configured to perform modeling of the subsurface region. The modeling of the subsurface region may be performed based on one or more coarse-scale subsurface representations, one of more fine-scale subsurface representations, and/or other information. Modeling of the subsurface region may include generation of one or more subsurface representations for the subsurface region. Modeling of the subsurface region may include use of subsurface representation(s) for the subsurface region to facilitate planning, development, production, and/or risk assessment of the subsurface region. Modeling of the subsurface region may include simulation of subsurface configuration of the subsurface region at moment(s) in time and/or for duration(s) of time (e.g., simulation of how subsurface configurations change within a subsurface region over time). Modeling of the subsurface region may include use of subsurface representation(s) for the subsurface region to simulate changes in the subsurface region during development (e.g., drilling of wells, completion of wells) and/or production (e.g., recovery of hydrocarbons from wells).

In some implementations, one or more coarse-scale subsurface representations and one of more fine-scale subsurface representations may be combined into a single subsurface representation (combined subsurface representation). The subsurface representations of different scales may be combined into a multi-scale subsurface representation. For example, as shown in FIG. 8, the combined representation 800 may include a multi-scale subsurface representation the coarse-scale representation 810 of a subsurface region and fine-scale representations 812, 814 of regions of interest within the subsurface region.

Spatial continuity and geological continuity may be preserved between the coarse-scale subsurface representation(s) (e.g., of the subsurface region) and the fine-scale subsurface representation(s) (e.g., of part(s) of the subsurface region). Spatial continuity may include continuity of subsurface property distributions across different subsurface representation. Geological continuity may include continuity of geological structures (e.g., channels/fans visible from seismic data). Both types of continuity may be preserved across different scales of subsurface representations.

The modeling of the subsurface region may be used for field development plans, well placement, assessing risks in the subsurface region, and/or production. For example, production in the subsurface region may be facilitated based on the modeling of the subsurface region and/or other information. For instance, the modeling of the subsurface region may be used for forecasting production, planning/controlling well operations (e.g., waterflooding, pressure management).

As used herein, the phrase “configured to” is intended to be interpreted broadly, as “being capable of or suitable for performing” some function or feature, without requiring any adaptations to provide said function or feature.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

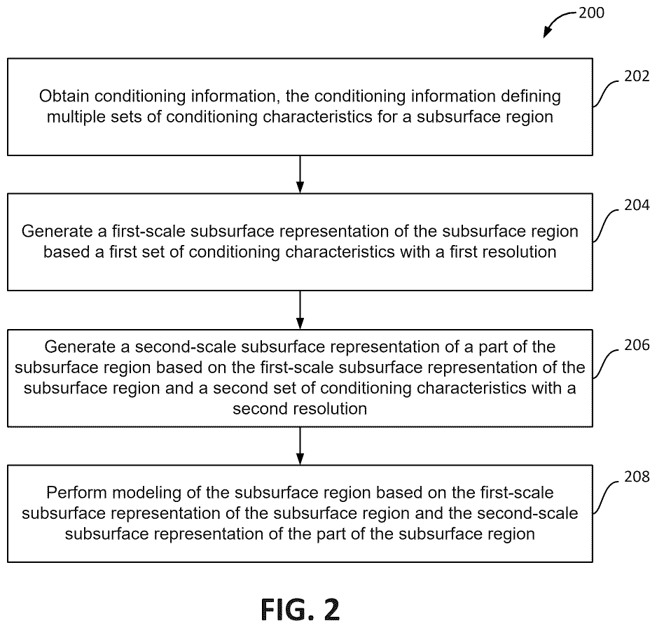

FIG. 2 illustrates method 200 for multi-scale subsurface modeling. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software for execution of one or more of the operations of method 200.

At operation 202, conditioning information may be obtained. The conditioning information may define multiple sets of conditioning characteristics for a subsurface region. The multiple sets of conditioning characteristics may include conditioning characteristics of different resolutions. The multiple sets of conditioning characteristics may include a first set of conditioning characteristics with a first resolution, a second set of conditioning characteristics with a second resolution higher than the first resolution, and/or other sets of conditioning characteristics. In some implementations, operation 202 may be performed by a processor component the same as or similar to the conditioning component 102 (Shown in FIG. 1 and described herein).

At operation 204, a first-scale subsurface representation of the subsurface region may be generated based on the first set of conditioning characteristics with the first resolution. The first-scale subsurface representation of the subsurface region may include a cell that represents a portion within the subsurface region. In some implementations, operation 204 may be performed by a processor component the same as or similar to the input coarse-scale component 104 (Shown in FIG. 1 and described herein).

At operation 206, a second-scale subsurface representation of a part of the subsurface region may be generated based on the first-scale subsurface representation of the subsurface region and the second set of conditioning characteristics with the second resolution. The second-scale subsurface representation of the part of the subsurface region may include multiple sub-cells that represent the portion within the subsurface region. In some implementations, operation 206 may be performed by a processor component the same as or similar to the fine-scale component 106 (Shown in FIG. 1 and described herein).

At operation 208, modeling of the subsurface region may be performed based on the first-scale subsurface representation of the subsurface region, the second-scale subsurface representation of the part of the subsurface region, and/or other information. In some implementations, operation 208 may be performed by a processor component the same as or similar to the modeling component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for multi-scale subsurface modeling, the system comprising:
one or more physical processors configured by machine-readable instructions to:
obtain conditioning information, the conditioning information defining multiple sets of conditioning characteristics for a subsurface region, the multiple sets of conditioning characteristics including conditioning characteristics of different resolutions, wherein the multiple sets of conditioning characteristics include a first set of conditioning characteristics with a first resolution and a second set of conditioning characteristics with a second resolution higher than the first resolution;
generate a first-scale subsurface representation of the subsurface region based on the first set of conditioning characteristics with the first resolution, the first-scale subsurface representation of the subsurface region including a cell that represents a portion within the subsurface region;
generate a second-scale subsurface representation of a part of the subsurface region based on the first-scale subsurface representation of the subsurface region and the second set of conditioning characteristics with the second resolution, the second-scale subsurface representation of the part of the subsurface region including multiple sub-cells that represent the portion within the subsurface region; and
perform modeling of the subsurface region based on the first-scale subsurface representation of the subsurface region and the second-scale subsurface representation of the part of the subsurface region.

2. The system of claim 1, wherein a given sub-cell of the multiple sub-cells of the second-scale subsurface representation that represents the portion within the subsurface region is populated with a given value based on a value of the cell of the first-scale subsurface representation that represents the portion within the subsurface region.

3. The system of claim 2, wherein the given sub-cell of the multiple sub-cells is a center sub-cell of the multiple sub-cells.

4. The system of claim 2, wherein other sub-cells of the multiple sub-cells of the second-scale subsurface representation that represent the portion within the subsurface region are not populated based on the value of the cell of the first-scale subsurface representation that represents the portion within the subsurface region.

5. The system of claim 2, wherein the given value is removed from the given sub-cell of the multiple sub-cells of the second-scale subsurface representation that represent the portion within the subsurface region based on the second set of conditioning characteristics with the second resolution including a conditioning characteristic value for the portion within the subsurface region.

6. The system of claim 5, wherein a non-center sub-cell of the multiple sub-cells of the second-scale subsurface representation that represent the portion within the subsurface region is populated with the conditioning characteristic value for the portion within the subsurface region based on the conditioning characteristic value corresponding to a non-center location within the portion.

7. The system of claim 1, wherein spatial continuity and geological continuity are preserved between the first-scale subsurface representation of the subsurface region and the second-scale subsurface representation of the part of the subsurface region.

8. The system of claim 1, wherein the conditioning information includes information from field exploration of the subsurface region, seismic exploration of the subsurface region, and/or production in the subsurface region.

9. The system of claim 1, wherein statistical correction is performed to generate the second-scale subsurface representation of the part of the subsurface region.

10. The system of claim 1, wherein production in the subsurface region is facilitated based on the modeling of the subsurface region.

11. A method for multi-scale subsurface modeling, the method comprising:
obtaining conditioning information, the conditioning information defining multiple sets of conditioning characteristics for a subsurface region, the multiple sets of conditioning characteristics including conditioning characteristics of different resolutions, wherein the multiple sets of conditioning characteristics include a first set of conditioning characteristics with a first resolution and a second set of conditioning characteristics with a second resolution higher than the first resolution;
generating a first-scale subsurface representation of the subsurface region based on the first set of conditioning characteristics with the first resolution, the first-scale subsurface representation of the subsurface region including a cell that represents a portion within the subsurface region;
generating a second-scale subsurface representation of a part of the subsurface region based on the first-scale subsurface representation of the subsurface region and the second set of conditioning characteristics with the second resolution, the second-scale subsurface representation of the part of the subsurface region including multiple sub-cells that represent the portion within the subsurface region; and
performing modeling of the subsurface region based on the first-scale subsurface representation of the subsurface region and the second-scale subsurface representation of the part of the subsurface region.

12. The method of claim 11, wherein a given sub-cell of the multiple sub-cells of the second-scale subsurface representation that represents the portion within the subsurface region is populated with a given value based on a value of the cell of the first-scale subsurface representation that represents the portion within the subsurface region.

13. The method of claim 12, wherein the given sub-cell of the multiple sub-cells is a center sub-cell of the multiple sub-cells.

14. The method of claim 12, wherein other sub-cells of the multiple sub-cells of the second-scale subsurface representation that represent the portion within the subsurface region are not populated based on the value of the cell of the first-scale subsurface representation that represents the portion within the subsurface region.

15. The method of claim 12, wherein the given value is removed from the given sub-cell of the multiple sub-cells of the second-scale subsurface representation that represent the portion within the subsurface region based on the second set of conditioning characteristics with the second resolution including a conditioning characteristic value for the portion within the subsurface region.

16. The method of claim 15, wherein a non-center sub-cell of the multiple sub-cells of the second-scale subsurface representation that represent the portion within the subsurface region is populated with the conditioning characteristic value for the portion within the subsurface region based on the conditioning characteristic value corresponding to a non-center location within the portion.

17. The method of claim 11, wherein spatial continuity and geological continuity are preserved between the first-scale subsurface representation of the subsurface region and the second-scale subsurface representation of the part of the subsurface region.

18. The method of claim 11, wherein the conditioning information includes information from field exploration of the subsurface region, seismic exploration of the subsurface region, and/or production in the subsurface region.

19. The method of claim 11, wherein statistical correction is performed to generate the second-scale subsurface representation of the part of the subsurface region.

20. The method of claim 11, wherein production in the subsurface region is facilitated based on the modeling of the subsurface region.
